(19) United States
(12) Patent Application Publication
(10) Pub. No.: US 2009/0138327 A1
(43) Pub. Date: May 28, 2009

(54) DELIVERY DATE ANSWERING PROGRAM, DELIVERY DATE ANSWERING METHOD, AND SYSTEM FOR IMPLEMENTING THE METHOD

(76) Inventors: Toshiyuki Sakuma, Yokohama (JP); Katsunari Ikezawa, Yokohama (JP); Naoyuki Katsube, Tokyo (JP); Mitsuhiro Enomoto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/815,230

(22) PCT Filed: Jan. 31, 2006
(86) PCT No.: PCT/JP2006/301559

§ 371 Date: Nov. 3, 2008

(30) Foreign Application Priority Data
Feb. 1, 2005 (JP) 2005-024676

(51) Int. Cl. G06Q 10/00; G06Q 30/00

(52) U.S. Cl. 705/10; 705/28

(57) ABSTRACT

This invention relates to a technique for enhancing the accuracy of sale quota information used in allocation for reservation of a delivery date reply to thereby shorten a sale-quota reply response time. Disclosed herein is a delivery date reply system which permits preallotment of a sales quota of a sellable distribution item and which is responsive to receipt of a delivery date inquiry for allocating for reservation the content of such inquiry from within the sale quota to thereby reply a delivery date and, when the inquiry content is not allocated to the sale quota, issues a reply as to a delivery date after having performed sale quota alteration simulation for alteration to a sale quota with maximal satisfaction of a customer's desired delivery date, quantity and item contents. The system has a means for storing history records of reception of the delivery date inquiry and execution of the sale quota alteration simulation, a computation means for computing based on the history data a ratio of a number of cases with completion of the execution of the sale quota alteration simulation to a number of inquiries per unit time to thereby check a resultant value in comparison with a predetermined reference value and detect a change when the value exceeds the reference value, a means for being activated upon detection of the change by the computation means and for updating the priority order of a sale-expected item that becomes a base of generation of the sale quota, and a sale quota generator means for generating a new expected sale quota based on a result of the updated priority order. When the computation means detects the change, the system updates the priority order of a sale-expected item serving as a base of generation of an expected sale quota and reads a result of the priority order to newly generate a sale quota for use in allocation for reservation of the delivery date reply.

### CROSS-REFERENCE TO RELATED APPLICATION

This application claims priority to Japanese Patent Application No. 2005-024676, filed Feb. 1, 2005, the contents of which are incorporated herein by reference.

### TECHNICAL FIELD

The present invention relates to a delivery date replying technique which permits preallotment of the sales quota of a sellable distribution item, which is responsive to receipt of a delivery date inquiry for allocating for reservation the content of such inquiry from within the sale quota to thereby reply a delivery date and for making, when the inquiry content is failed to be allocated to the sale quota, a reply as to a delivery date after having performed sale quota alteration simulation for alteration to a sale quota with maximal satisfaction of a delivery date desired by a customer and quantity and item contents.

### BACKGROUND ART

Generally, a function which permits preallotment of the sale quota of a sellable distribution item and, upon acceptance of a delivery date inquiry, allocates for reservation the inquiry content from within said sale quota and then makes a reply indicating the delivery date is called the ATP (Available To Promise) function. In addition, a function which performs, when said inquiry content is not allocated for reservation to said sale quota, sale quota alteration simulation to thereby change it to a sale quota that maximally satisfies a customer's desired delivery date, quantity, item contents and others and then issues a reply as to the delivery date is called the CTP (Capable To Promise) function.

A known technique relating to this delivery date reply is disclosed, for example, in Japanese Patent No. 3327235.

Also note that in addition to the technique as to the above-noted ATP/CTP delivery date reply, another known technique (seat reservation scheme) relevant to the delivery date reply is disclosed in JP-A-2004-157922, which prepares a production schedule after having received an order and adapt a plan to the customer's needs.

In recent years, customer needs grow in diversity and multiformity, resulting in an increase in variation of commercial products when compared to the prior art. Under such circumstances, in a field of parts-assembly production, a flexible remedy is employed to keep pace with the diversification of the customer needs by using mixed-flow line architectures for performing assembly production of many different types of items by the same line. However, on the other hand, an increase in variation of products gives rise to decreases in demand forecast accuracy, system processing time and operating efficiency or else, resulting in occurrence of managerial and pragmatic problems, such as an increase in delivery date reply response time and/or an increase in stock excess/deficiency.

It is therefore an object of this invention to enhance the accuracy of sale quota information for use in allocation for reservation of a reply as to delivery date, thereby to shorten a response time taken for the delivery date replying.

### DISCLOSURE OF INVENTION

This invention provides a delivery date reply system which manages more than one sellable distribution item as a sale quota containing therein at least identification information and quantity information thereof in a way corresponding to each sellable time point and which has a sale quota data table for management of the sale quota while letting said sale quota be divided into a settled sale quota storing therein information of an item with its customer order being fixed and an expected sale quota storing therein information of an item expected to be sold which is determined by demand forecast based on actual shipping results. And, it is the delivery date reply system which is responsive to receipt of a delivery date inquiry for replying a delivery date when the item under inquiry is allocatable for reservation from said expected sale quota, and for performing, when said item under inquiry is not allocatable from within said expected sale quota, sale quota alteration simulation to change the expected sale quota of said sale quota data table in such a way as to fully or partly satisfy the customer's desired delivery date and quantity and item contents to thereby send a reply as to the delivery date toward an inquiring party. And further, it is the system which is characterized by comprising means for storing a history record of reception of the delivery date inquiry and a history record of execution of the sale quota alteration simulation, computation means for computing based on the history data a ratio of a number of cases with completion of the execution of said sale quota alteration simulation to a number of inquiries per unit time to thereby check a resultant value in comparison with a predetermined reference value and detect a change when the value is in excess of the predetermined reference value, means for being rendered operative upon detection of said change by said computation means and for updating the priority order of a sale-expected item which becomes a base of generation of the sale quota, and sale quota generator means for generating a new expected sale quota based on a result of said priority order updated.

### BEST MODE FOR CARRYING OUT THE INVENTION

One preferred form of the delivery date reply system in accordance with the present invention will be explained below.

<Entire Configuration of Delivery Date Reply System>

An explanation will be given, using FIG. 1, of a model of a commercial distribution network to which the delivery date reply system embodying the invention is applicable and a configuration of the delivery date reply system of this embodiment. As shown in FIG. 1, the distribution network model is under an assumption that an item 6, such as a product, component, half-completed product, in-process article, raw material or the like, is delivered by a transport means 5 or else from a supplier ε finally to a marketplace δ by way of an industrial plant or factory β and a sales company α and others.

Regarding the delivery date reply system, this is a system for management of plan information, actual achievement information and various parameters to thereby realize issuance of a reply indicating a delivery date. This delivery date reply system has a sales company-side terminal 1 which is disposed at the sales company α or the like, a factory-side terminal 2 that is disposed in the factory β, and a management center-side terminal 3 disposed in a management center γ. Respective terminals 1-3 are connected to a network 4, and any two of them are mutually communicable via the network 4 for transmission and receipt of various kinds of data therebetween. As shown in FIG. 5, each of the terminals 1-3 is a computer having an input device 32 such as a keyboard and/or a mouse, an output device 33 such as a display, an auxiliary storage device 34, and an arithmetic processing device 31 for execution of various kinds of software programs, including a delivery date reply program. The arithmetic processing device 31 is generally made up of a central processing unit (CPU) 31A, a main storage device 31B and an interface 31C. This arithmetic processor device 31 is operatively connected via the interface 31C to the input device 32, output device 33 and auxiliary storage device 34.

In this embodiment, execution results of various programs, such as the delivery date reply program, are stored in a memory area that is provided in the main storage device 31B. Various programs are preinstalled in the auxiliary storage device 34 and, thereafter, read into the main storage device 31B for execution by the CPU 31A. Owing to this CPU 31A's execution of various programs, each function to be described later is realizable.

Note here that although in the illustrative embodiment an exemplary case is discussed where each terminal constituting the delivery date reply system is realized by a general-purpose information processing apparatus and software, the same may alternatively be realized by use of a hardware including a hard-wired logic and a preprogrammed general-purpose data processing apparatus associated in combination with such the hardware.

Also note that although in this embodiment the delivery date reply system is explained as a decentralized processing system, this invention should not exclusively be limited thereto. It is also considered that this invention permits the use of a configuration which is built in other data processing systems for functioning as part of them. Alternatively, it may also be permissible to realize the same by redesigning part of each terminal function or dividing it into small parts or combining functions together.

Next, an explanation will be given of functional configurations of respective terminals 1-3 making up the delivery date reply system and data to be held by respective terminals 103 with reference to FIGS. 2-4 and FIGS. 6-16.

<Sales Company-Side Terminal Configuration and Hold Data Contents>

As shown in FIG. 2, the sales company-side terminal 1 of this embodiment has an arithmetic processing unit 110 which executes various types of software programs, a storage unit 120 for storage of various kinds of data, an input/output unit 130 which performs input/output of various data, and a network interface (IF) unit 140 for connection to the network 4.

The arithmetic processing unit 110 has an order data management unit 111 which performs input/output of order data and registration to the storage unit 120, and a shipping result data management unit 112 that performs input/output of actual shipping result data of one or more items and registration to the storage unit 120. Each function unit 111, 112 of the arithmetic processor unit 110 is rendered operative by the CPU 31A's execution of various programs as stated previously. Detailed explanations of the operations of these function units 111-112 will be set forth in the context of an explanation of a processing flow in due order.

The storage device 120 has an order data storage unit 121 in which the information of an order received from a customer and a shipping result data storage unit 122 for storage of the actual shipping result of an item or items that have been shipped to the customer.

The order data storage unit 121 is arranged to store therein order data including, but not limited to, an ordering number, identification (ID) information of an item ordered, customer information, delivery date, quantity, delivery date inquiring time, order acceptance time, etc. Practically, as shown in FIG. 6, the order data storage unit 121 has a field 1211 for registration of an order number to be issued, once at a time, whenever an order is accepted, a field 1212 for registration of ID information of order-accepted items, a field 1213 for registration of customer information, a field 1214 for registration of delivery dates, a field 1215 for registration of the quantity or number of the order-accepted items, a field 1216 for registration of information at time points of the delivery date inquiry, and a field 1217 for registration of information at order acceptance time points, wherein the individual order data is updated once at a time whenever an order is accepted.

The shipping result data storage unit 122 stores therein actual shipment result data, such as a shipping number, ID information of an item to be shipped, shipping destination information, quantity, shipping time points and others. More specifically, as shown in FIG. 7, the shipping result data storage unit 122 has a field 1221 for registration of a shipping number to be issued upon each shipment, a field 1222 for registration of ID information of an item(s) to be shipped, a field 1223 for registration of shipping destination information, a field 1224 for registration of the quantity or number of the items under shipment, and a field 1225 for registration of information of shipping time points, wherein the shipment result data is updated, once at a time, whenever shipping is done.

<Factory-Side Terminal Configuration and Hold Data Contents>

As shown in FIG. 3, the factory-side terminal 2 of this embodiment has an arithmetic processing unit 210 for execution of various types of programs, a storage unit 220 for storage of various kinds of data, an input/output unit 230 which performs input/output of various data to and from its associated peripheral equipment, such as a keyboard and/or a display or else, and a network IF unit 240 for connection to the network 4.

The arithmetic processing unit 210 has a demand forecast unit 211 which performs item demand forecast, input/output of demand forecast data and registration to the storage unit 220, a stock status data management unit 212 which performs input/output of stock status data and registration to the storage unit 220, a sale quota generator unit 213 which performs generation of sale quota data, generation of more than one sale quota proposal (such as sale quota alteration simulation or else) and transmission of the sale quota data to the management center-side terminal 3, and a priority order master data management unit 214 which performs input/output of a priority order master and registration to the storage unit 220. Each function unit 211, 212, 213, 214 of the arithmetic processor unit 210 is rendered operative by the CPU 31A's execution of various programs as stated previously. Detailed explanations of the operations of these function units 211-214 will be set forth in the context of an explanation of a processing flow in due order.

The storage unit 220 has a demand forecast data storage unit 221 in which a result of demand forecast is stored, a stock status data storage unit 222 for storage of stock status information of an item(s), a delivery schedule data storage unit 223 which stores therein information of an item(s) to be delivered from the supplier ε to the factory β, an item arrangement master data storage unit 224 which stores information of upper/lower-level relevancy of the item and a “head count” number of constituent members thereof, a production-ability master data storage unit 225 which stores information of production-related production ability and information of a production time on a per-item basis, and a priority order master data storage unit 226 which stores priority order information of an upper-level item(s) concerning the generation of a sale quota.

The demand forecast data storage unit 221 stores therein a demand forecast result 2211 per top-level item, low-level item attachment ratio prediction results 2212, and demand forecast results 2213 in units of low-level items. Practically, as shown in upper part of FIG. 8, the demand forecast data storage unit 221 has at 2211 a field 2211a for registration of ID information of the top-level item, a field 2211b for registration of time points of execution of demand forecast, a field 2211c for registration of forecast target time points, and a field 2211d for registration of a demand forecast quantity or number. Note that the demand forecast quantity per top-level item may be calculated based on prediction techniques, such as a running average method, after having combined together the number of upper-level items of the actual shipment result data in units of top-level items by use of item configuration master data to be later described or, alternatively, may be obtained through direct input by a stuff in charge of the sales company. In addition, as shown in mid part of FIG. 8, the demand forecast data storage unit 221 has at 2212 a field 2212a for registration of the top-level item's ID information, a field 2212b for registration of the low-level item's ID information, a field 2212c for registration of time points that the demand forecast is performed, a field 2212d for registration of forecast target time points, and a field 2212e for registration of predicted attachment ratios. Note here that the low-level item attachment ratio may be determined by a process having the steps of combining together the quantity of upper-level items of the shipping result data per top-level item, expanding it to a low item level(s) by using item configuration master data as will be described and explained later, combining the quantity on a per-low level item basis, dividing it by a total shipping quantity on a per-top level item to determine a ratio, and then calculating it based on a prediction technique, such as a moving average method; alternatively, the same result is obtainable by direct entry by a stuff in charge of the sales company. Additionally as shown in lower part of FIG. 8, the demand forecast data storage unit 221 has at 2213 a field 2213a for registration of ID information of top-level item, a field 2213b for registration of low-level item ID information, a field 2213c for registration of time points of execution of demand forecast, a field 2213d for registration of demand forecast target time points, and a field 2213e for registration of demand forecast quantity/number. Note that the low-level item's demand forecast quantity is calculated based on the top-level item demand forecast result and low-level item demand forecast result. For example, a demand forecast number, eighty, of low-level item demand forecast result 2213f is obtained through multiplication of a predicted attachment ratio 80% of low-level item demand forecast result 2212f by a demand forecast number, one hundred, of top-level item demand forecast result 2211e.

It should be noted that the above-stated demand forecast is performed because of the fact that there is the tendency of an increase in variation of products in recent years. It is very likely that the accuracy of demand forecast values due to prior art schemes for performing demand forecast in units of upper-level items will decrease in near future. In view of this, the embodiment of this invention is arranged to perform demand forecast by a new demand forecast technique of the type stated supra.

The stock status data storage unit 222 stores therein stock status data including but not limited to the information of an inventory location at which items are stocked, ID information of such items in stock, a stock number, stock status, and a stock status update time point(s). More specifically, as shown in FIG. 9, the stock status data storage unit 222 has a field 2221 for registration of information of the item stock location, a field 2222 for registration of ID information of items in stock, a field 2223 for registration of stock numbers, a field 2224 for registration of stock status, and a field 2225 for registration of stock status update time points. Note here that the “stock” of the stock status is a status existing at the inventory location β as the stock whereas “in-process” is a stock status in the process of being manufactured.

The delivery schedule data storage unit 223 stores therein delivery schedule data in units of order/unofficial announcement numbers, such as ID information of a low-level item(s) under ordering/unofficial notice, a number or quantity ordered and unofficial notified, a destination of the order/unofficial notice (i.e., supplier), information of time points of some major events such as unofficial notice, ordering and delivery instruction, and progress status. Practically as shown in FIG. 10, the delivery schedule data storage unit 223 has a field 2231 for registration of order/unofficial-notice numbers, a field 2232 for registration of ID information of ordered items with unofficial notices issued, a field 2233 for registration of order/unofficial-notice numbers, a field 2234 for registration of information of the order/unofficial-notice destination (supplier), a field 2235 for registration of information of unofficial notice time points, a field 2236 for registration of information of ordering time points, a field 2237 for registration of information of a time point that delivery was instructed, and a field 2238 for registration of progress status.

The item arrangement master data storage unit 224 stores therein item arrangement master data, such as the relevancy of top-level and upper-level items, relevancy of upper- and lower-level items, and a number of constituent members. More specifically, as shown in lower left part of FIG. 11, the item arrangement master data storage unit 224 has a field 2241 for registration of ID information of top-level items and a field 2242 for registration of ID information of upper-level items, which fields are used to represent the relevancy of top- and upper-level items.

Additionally as shown at lower right part in FIG. 11, it has a field 2243 for registration of ID information of upper-level items, a field 2244 for registration of ID information of low-level items, and a field 2245 for registration of a constituent member number, which are used to represent the relevancy of upper- and lower-level items. Note that a drawing within a box 2240 at upper part of FIG. 11 indicates that a top-level item (Model 1) consists essentially of upper-level items x1, x2, . . . , wherein the upper-level item x1 is made up of an item a, item b and item d, each of which is one-rank lower in level.

The production-ability master data storage unit 225 stores therein production-ability master data, such as productability information 2251 relating to mass-production and per-item production time 2252. Practically, as shown at upper part of FIG. 12, the productability master data storage unit 225 has at 2251 a field 2251a for registration of ID information of a factory for manufacturing upper-level items, a field 2251b for registration of a time axis of sale quota, a field 2251c for registration of productability within a fixed length of time period (e.g., the unit of such ability is hour), and a field 2251d for registration of overtime working capabilities. In addition, as shown at lower part of FIG. 12, the productability master data storage unit 225 has at 2252 a field 2252a for registration of ID information of upper-level items, a field 2252b for registration of mounting/attachment numbers of low-level items, and a field 2252c for registration of a production time of each upper-level item (equal to a time of from attachment of a low-level item up to completion of an upper-level item).

The priority order master data storage unit 226 stores therein upper-level item's priority order information concerning the generation of a sale quota. More precisely as shown in FIG. 13, the priority order master data storage unit 226 has a field 2261 for priority order registration, a field 2262 for registration of upper-level item ID information, and a field 2263 for registration of preset weighting coefficients for facilitating preferential selection (i.e., the higher the weighting, the higher the possibility of selection). A record 2260 of FIG. 13 shows that an item x8 is the highest in order, with its weight being set up for guaranteeing selection by priority.

<Management Center-Side Terminal Configuration and Hold Data Contents>

As shown in FIG. 4, the management center-side terminal 3 of this embodiment has an arithmetic processing unit 310 for execution of various types of programs, a storage unit 320 for storage of various kinds of data, an input/output unit 330 for performing input/output of various data, and a network IF unit 240 for connection to the network 4.

The arithmetic processor unit 310 has a delivery date inquiry data management unit 311 which performs issuance of a delivery date inquiry number, registration of delivery date inquiry data to the storage unit 320, delivery date answering processing, judgment using the delivery date inquiry data (delivery date reply response judgment), priority order calculation, and transmission of a new priority order result toward the factory-side terminal 2, a sale quota data management unit 312 which performs input/output of sale quota data, registration of the sale quota data to the storage unit 320, transmission of the sale quota data to the factory-side terminal 2, updating of the sale quota data and judgment using the sale quota data (stock retention decision), and a sale quota checker unit 313 which performs checking of the delivery date inquiry data and the sale quota data, registration of a check result to the storage unit 320, and transmission of the check result to the factory-side terminal 2. Each functional unit 311, 312, 313 of the arithmetic processor unit 310 is activated by the CPU 31A's execution of various programs as stated supra. Detailed explanations of the operations of these function units 311-313 will be set forth in the context of an explanation of a processing flow in due order.

The storage unit 320 has a delivery date inquiry data storage unit 321 which stores a history record of delivery date inquiries, a sale quota data storage unit 322 which stores sale quotas of sold or sellable items, and a decision standard master data storage unit 323 which stores a judgment standard for comparison with a delivery date reply response index and/or a stock retention index as will be described later.

The delivery date inquiry data storage unit 321 stores therein the history of delivery date inquiries. More specifically as shown in FIG. 14, the delivery date inquiry data storage unit 321 has a field 3211 for registration of an inquiry number to be issued upon occurrence of a delivery date inquiry, a field 3212 for registration of time points of occurrence of delivery date inquiries, a field 3213 for registration of demanded items under inquiry, a field 3214 for registration of delivery dates designated, a field 3215 for registration of demanded item numbers, a field 3216 for registration of time points of item allocation for reservation to sale quotas, a field 3217 for registration of delivery date judgment results, a field 3218 for registration of the presence or absence of operation of sale quota proposal generation processing in failure of allocation to a preallotted sale quota, and a field 3219 for registration of allocated regions.

The sale quota data storage unit 322 stores sale quotas of sold or sellable items. Practically as shown in FIG. 15, the sale quota data storage unit 322 has a field 3221 for registration of order numbers, a field 3222 for registration of inquiry numbers, a field 3223 for registration of the time axis of each sale quota, a field 3224 for registration of ID information of upper-level items, a field 3225 for registration of sale quota allocation statuses, a field 3226 for registration of demanded item numbers, a field 3227 for registration of present stock statuses, and a field 3228 for registration of sale quota proposal generation history. Here, an explanation is given of the contents of a sale quota with reference to FIG. 21. A period of from a time point t to a time point t+i−1 is in the process of item production or in the state that item production is completed, wherein a time point t+i is an instant of the final change of a sale quota. Additionally, t+k is a sale quota generation target time point, which is also an instant for performing unofficial announcement of a demanded low-level item(s) to the supplier ε. The sale quota is generated and modified periodically, once per unit time (e.g., per week). A region I refers to the region that the quantity of a low-level item for use in the manufacture at each time point has already been determined. In the example shown in FIG. 21, every sale quota that is stacked at the time point t of sales time axis in the region I is a settled sale quota, which is no longer capable of allocating for reservation any sale quota with respect to an upper-level item(s) required. Although an expected sale quota is present in a period of from a time point t+1 to time point t+i−1, no sale quotas are alterable because of the fact that those upper-level items to be allotted to the production line have already been settled. However, as for an expected sale quota existing between time points t+i to t+i−k, sale quota alteration is executable as far as a low-level item quantity required is kept unchanged even in cases where identical required upper-level items are absent. For example, at time point t+k−1, low-level items needed by the upper-level items x1, x2, x5 and x8 have already been arranged and prepared; thus, it is possible to achieve alteration to another manufacturable upper-level item combination by using these preparation-completed low-level items. In contrast, a region II is the one with unofficial announcement of low-level item being not performed yet: a period of from a time point t+k+1 to time point t+n is a region capable of stacking a demanded upper-level item as the sale quota as far as it is kept less than the production ability or “productability.” When it is impossible to allocate for reservation any upper-level item which is an object under inquiry in the region I and region II, such required item is stacked in a region III.

The decision standard master data storage unit 323 stores therein decision standards or criteria for comparison with a delivery date reply response index and a stock retention index to be later described. Practically as shown in FIG. 16, the decision standard master data storage unit 323 has a field 3231 for registration of ID information of top-level items, a field 3232 for registration of stock retention criteria, and a field 3233 for registration of delivery date reply response standards.

<Sale Quota Generation Processing>

Sale quota generation processing will be explained using FIG. 17. The sale quota generation processing is made up of three steps: a process (S1701) for reading shipping result data at the sales company-side terminal 1 and sending such data to the factory-side terminal 2, a process (S1702) for performing demand forecast and sale quota generation at the factory-side terminal 2, and a process (S1703) for registering the sale quota data to the sale quota data storage unit 322 at the management center-side terminal 3.

A sale quota generation method of S1702 will be explained below. What is done first is to acquire demand forecast information at time point t+k from the demand forecast data storage unit 221 (low-level item demand forecast 2213). In addition, an attempt is made to acquire from the item arrangement master data storage unit 224 the required quantity information with respect to an upper-level item. Next, in order to determine an optimal sales quantity of the upper-level item, a linear programming method is used to solve a modelized combination optimization problem. Below is an explanation of the content of such model. Letting a set of upper-level items be given as I, each upper-level item be i, a sales quantity of i be xᵢ, and a predicted total sales number of upper-level item be G, Equation (1) below is established, because the total sales number of upper-level item must be equal to the predicted sales quantity.

$$\begin{matrix}[ EQU 1 ] & \\ {\sum }_{i ∈ I} {x}_{i} = G & Λ ( 1 )\end{matrix}$$

Letting a set of low-level items be J, each low-level item be j, and a number of low-level items j needed to manufacture a single upper-level item i be Mᵢⱼ, Mᵢⱼ is obtainable from the constituent member number 2245 of the item arrangement master data storage unit 224. An example is that when low-level items a, b, d are necessary for the upper-level item x1, the following is given: M₁ₐ=1, M_{1b}=1, M_{1c}=0, M_{1d}=1.

Letting the predicted quantity 2213e of a low-level item j acquired from the demand forecast data storage unit 221 (low-level item demand forecast 2213) be Dⱼ, in order to manufacture the upper-level item while using an adequate number of low-level items that have been purveyed and prepared to satisfy the demand forecast in the absence of any excess and deficiency, it is required that the total number of those low-level items obtained by expanding the upper-level item is identical to the predicted quantity 2213e. The number of low-level items to be used is representable by a total sum of xxM. An exemplary approach to obtaining a required number of low-level item a is to add a number—here, 18—indicative of a product of a sales number “18” of x2 and the constituent member number “1” of low-level item a to a multiplied number, 30, of the sales number “30” of x1 and the constituent member number “1,” and sequentially perform similar addition for every low-level item involved. In FIG. 20, the low-level item a's necessary number calculated is 95. Misfit can sometimes occur between this calculated necessary number and the predicted required number. Letting positive misfit of the low-level item's necessary number calculated and necessary number predicted be d⁺ and negative misfit be d⁻, the low-level item j's positive misfit becomes dⱼ⁺ whereas its negative misfit is dⱼ⁻; thus, the following constraint equation (2) concerning such low-level item is defined.

$$\begin{matrix}[ EQU 2 ] & \\ {\sum }_{i ∈ I} ( {x}_{i} \times {M}_{ij} ) = {D}_{j} - {d}_{j}^{-} + {d}_{j}^{+} , j ∈ J & Λ ( 2 )\end{matrix}$$

In order to avoid deficiency of the low-level item and excessive stock of low-level item at the time of manufacturing, the misfit of low-level item may be kept at zero. Accordingly, the objective function for minimization of a total of misfits of low-level item from the predicted value is given by Equation (3) below.

$$\begin{matrix}[ EQU 3 ] & \\ min {\sum }_{j ∈ J} ( - {d}_{j}^{-} + {d}_{j}^{+} ) & Λ ( 3 )\end{matrix}$$

By inputting to the above-noted model the demand forecast information at time point t+k and the required quantity information of low-level item and then solving using the linear programming method, it is possible to calculate the number of item xᵢ, which becomes minimized in excess and deficiency of components. A resultant upper-level item combination and its quantity are for use as an expected sale quota at the time point t+k.

<Processing from Delivery Date Inquiry to Order Acceptance>

A procedure of processing of from delivery date inquiry to order acceptance will be explained using FIG. 18.

The processing of from delivery date inquiry to order acceptance is generally made up of eight process steps which follow: inquiry data input processing (S1801) to be performed by the sales company-side terminal 1, sale quota check processing (S1802) to be done by the management center-side terminal, sale quota proposal generation processing (S1803) by the factory-side terminal 2, sale quota proposal registration processing (S1804) by the management center-side terminal 3, delivery date reply data read/send processing (S1805), delivery date reply result output processing (S1806), order data input processing (S1807), and sale quota update processing (S1808). Details of respective processes will be described below.

(1) Inquiry Data Input Processing (S1801)

Regarding the sales company-side terminal 1, inquiry data registration is performed. For example, from a display screen “Delivery Date Inquiry Input” such as shown in FIG. 27, a demanded item, required quantity and desired due date are registered. Pushing down a delivery date inquiry button 271 results in the inquiry data being sent to the management center-side terminal 3.

(2) Sale Quota Check Processing (S1802)

The management center-side terminal 3 reads sale quota data from the sale quota data storage unit 322. Here, check with the sale quota; then, register a check result to the delivery date inquiry data storage unit 321. Details of the check processing are shown in FIG. 22. When the demanded item is capable of being allocated for application by the expected sale quota, go to process step S1805. If it cannot be allocated to the expected sale quota, the check result is sent to the factory-side terminal 2.

(3) Sale Quota Proposal Generation Processing (S1803)

The factory-side terminal 2 performs readout of various kinds of data and generation of a sale quota proposal. Details of this processing are shown in FIGS. 23A and 23B.

Referring to FIG. 24, a procedure of sale quota allocation/reservation processing will be explained under an assumption that a desired delivery date is t+f and an upper-level item x1 is under delivery date inquiry.

At present, the sale quota at time point t+f is such that four upper-level items x3, x4, x5 and x6 are allotted thereto. Some of them, i.e., x5 and x6, are each an already settled or “fixed” sale quota and thus are no longer alterable. The items x3 and x4 are each an expected sale quota: these two items are changeable. Let x3, x4 be expanded to low-level items, followed by searching of a manufacturable upper-level item in combination with such low-level items in accordance with the above-stated sale quota generation method. A result of this searching reveals the fact that x1 and x2 are manufacturable; thus, let x1 be allocated for reservation to the demanded item to thereby provide a newly settled sale quota while registering x2 as an expected sale quota proposal.

The sale quota proposal thus generated is sent from the factory-side terminal 2 to the management center-side terminal 3.

(4) Sale Quota Proposal Registration Processing (S1804)

The management center-side terminal 3 operates to store the sale quota proposal sent from the factory-side terminal 2 in the storage unit 320 and, additionally, causes the check result to be reflected on the data storage unit 321.

(5) Delivery Date Reply Data Read/Send Processing (S1805)

The management center-side terminal 3 generates delivery date inquiry data. Based on the allocation time point field 3216 and delivery date decision field 3217 of the delivery date inquiry data storage unit 321, this terminal generates delivery date inquiry data, such as “Delivery Date OK” in case the demanded item is deliverable by the delivery date, “Delivery Date NG” when the delivery date is incapable of being kept, or “Delivery Date Proposal Presentation” displaying the earliest possible delivery date promising that the item is deliverable on the earliest day if the desired delivery date cannot be kept, and then sends the data to the sales company-side terminal 1.

(6) Delivery Date Reply Result Output Processing (S1806)

A delivery date reply result received is output to the output device of the sales company-side terminal 1. An exemplary display screen of such delivery date reply result is shown at lower part of FIG. 27.

(7) Order Data Input Processing (S1807)

In case where a user of the sales company-side terminal 1 ascertains the delivery date reply result by the sales company-side terminal 1 and satisfies such result and wants to give way to ordering directly, s/he inputs order data by using the input/output unit of sales company-side terminal 1 and performs registration of the order data. Upon completion of the registration, the order data is sent forth to the management center-side terminal 3 and accepted thereby as a formal order.

(8) Sale Quota Update Processing (S1808)

The management center-side terminal 3 is responsive to receipt of the formal order data from the sales company-side terminal 1, for performing update processing of the sale quota and then sending to the sales company-side terminal 1a notice saying that the order has been accepted.

<Sale Quota Alteration Processing>

Sale quota alteration processing will be explained using FIG. 19. The sale quota alteration processing consists essentially of a stock retention decision processing step (S1901) and a delivery date reply response decision processing step (S1902), which are performed by the management center-side terminal 3, and a sale quota update processing step (S1903) to be done by the factory-side terminal and also a sale quota registration processing step (S1904) by the management center-side terminal. Below is a detailed explanation of each step.

(1) Stock Retention Decision Processing (S1901)

The management center-side terminal 3 reads the sale quota data, once at a time, when a unit time is elapsed. For the sale quota, there exist a settled sale quota which is related to order acceptance and an expected sale quota that is not yet related to any specific order acceptance. If the ratio of the expected sale quota to the entire sale quota is large, it is considered that there is a problem as to the accuracy of expectancy. A procedure of stock retention judgment will be explained using FIG. 25. What is done first is to calculate a stock retention index or “barometer.” This stock retention index is the ratio of an expected quota number to demand forecast quantity. In the example of FIG. 25, the stock retention index is 64%. Next, compare the calculated stock retention index to a stock retention reference value that is obtainable from the decision standard master data storage unit 323. When the stock retention reference value being presently registered to the decision standard master data is 60%, the value of the stock retention index is in excess of this value, so a decision is made to specify that the judgment result is NG, followed by transition to S1902. If the value of the stock retention index does not exceed this value, it is judged that the accuracy of demand forecast is sufficiently high and thus alteration of the sale quota is not performed. Note here that although the description assumes that the stock retention judgment is done at unit time intervals, this judgment may alternatively be implemented, once at a time, whenever a delivery date inquiry occurs.

(2) Delivery Date Reply Response Decision Processing (S1902)

Upon judgment of NG at S1901, the management center-side terminal 3 performs delivery date reply response judgment. Below is an explanation using FIG. 26 as to a procedure of the delivery date reply response judgment. First, an attempt is made to acquire a number of delivery date inquiry cases, a number of sale quota proposal generation cases, and information of a total quantity or number of demanded items; then, perform counting in units of upper-level items. Using a result thereof, calculate a delivery date reply response index. The delivery date reply response index is the ratio of the sale quota proposal case number to the inquiry case number. It is considered that the higher this ratio, the greater the execution number of sale quota proposal generation at the time of delivery date replying—accordingly, the worse the response of delivery date reply. Next, compare the calculated delivery date reply response index with a delivery date reply response reference value that is obtainable from the decision standard master data storage unit 323, thereby performing judgment. In the example of FIG. 26, the delivery date reply response index is more than the reference value, so its judgment result becomes NG. In the case of the judgment of NG, send priority order data to the factory-side terminal 2. In responding thereto, the factory-side terminal 2 performs priority order master update processing. In FIG. 26, it is shown that the priority orders of upper-level items are resorted so that an item with a greater inquiry case number is ranked at a higher level.

(3) Sale Quota Update Processing (S1903)

Using the updated priority order master, alter the sale quota to the latest state. Then, add to the above-stated linear programming model in the sale quota generation an index for allotting to the sale quota a larger number of items that are large in inquiry case number. First, let those items of the generated sale quota be resorted in an ascending order; then, added thereto priority orders; next, compare with a rank order of the priority order master on a per-item basis. In case a difference takes place in such order, add a weighting value as a penalty and then add a total penalty value to the objective function, thereby solving the optimization problem for minimization of the penalty. As a result, it is possible to generate a sale quota which is large in number of items that are high in priority order and yet less in number of items that are low in priority order.

(4) Sale Quota Registration Processing (S1904)

The factory-side terminal 2 sends forth the updated sale quota toward the management center-side terminal 3. The management center-side terminal 3 registers its received sale quota data to the sale quota data storage unit 322. In addition, output the delivery date reply response index and stock retention index to the output device in such a way as to enable a person in charge of planning to recognize the accuracy of sale quota prediction. See FIG. 28, which shows an example of the display means of the sale quota prediction accuracy and the sale quota obtained. By referring to the sale quota prediction accuracy index, it is possible to quantitatively analyze the stock retention and delivery date reply response and also contemplate a proper remedy therefor. For example, as shown in FIG. 29, it is considered that if the stock retention standard is low and also the delivery date reply response is low, adequate demand forecast accuracy can be held. However, if the delivery date reply response is high in spite of the fact that the stock retention standard is low, this indicates the presence of tendency of frequently generating sale quota proposals regardless of the high ratio of the settled sale quota. If this is the case, a remedy is considered, such as further increasing the total demand quantity. Alternatively, in cases where the stock retention standard is high and the delivery date reply response is low, it is considered that there is the tendency that relatively many expected sale quotas remain and, at the same time, the delivery date inquiry case number per se is kept less; thus, it becomes necessary to provide a remedy for sales promotion and others. Adversely, in case the stock retention standard is high and the delivery date reply response is high, it is considered that a large number of inquiries are received, almost none of which are failed to be allocated for reservation to the settled sale quota, resulting in the prediction accuracy per se being faced with problems; thus, a need is felt to make a study on improvement of an internal structure. One exemplary approach to doing this is to perform revision and redesigning of the expected sale quota by updating the priority order of item selection in the way which has been explained in the illustrative embodiment.

### INDUSTRIAL APPLICABILITY

According to this invention, by providing a series of means for enhancing the accuracy of sale quota information for use in allocation for reservation of a delivery date inquiry, sale quota alteration simulation is reduced in frequency of execution upon acceptance of an order. Thus it is possible to shorten the delivery date reply response time. In addition, according to this invention, it is possible to lessen the risk of unwanted excess and deficiency of parts or components in stock since an appropriate sale quota is generated by computation for determining the optimum solution that satisfies the goal of reducing excess and deficiency of stock components.

Further, according to this invention, other advantages are achievable including, but not limited to, improvement in demand forecast accuracy, improvement of delivery date adherence/keeping rate, and decrease in system workload, such as the sale quota alteration simulation processing or the like.

Although the invention has been particularly shown and described with reference to the specific embodiment thereof, it will be understood by those skilled in the art that the foregoing and other changes in form and details may be made therein without departing from the spirit and scope of the invention as claimed.

### BRIEF DESCRIPTION OF DRAWINGS

FIG. 1 An explanation diagram showing a delivery date reply system configuration in accordance with one embodiment of the present invention.

FIG. 2 A functional arrangement diagram of a sales company-side terminal in accordance with one embodiment of this invention.

FIG. 3 A functional arrangement diagram of a factory-side terminal in accordance with one embodiment of this invention.

FIG. 4 A functional arrangement diagram of a management center-side terminal in accordance with one embodiment of the invention.

FIG. 5 A hardware arrangement diagram of each terminal in the delivery date reply system in accordance with one embodiment of the invention.

FIG. 6 An explanation diagram showing a data structure of an order data storage unit in accordance with one embodiment of the invention.

FIG. 7 An explanation diagram showing a data structure of a shipping result data storage unit in accordance with one embodiment of the invention.

FIG. 8 An explanation diagram showing a data structure of a demand forecast data storage unit in accordance with one embodiment of the invention.

FIG. 9 An explanation diagram showing a data structure of a stock status data storage unit in accordance with one embodiment of the invention.

FIG. 10 An explanation diagram showing a data structure of a delivery schedule data storage unit in accordance with one embodiment of the invention.

FIG. 11 An explanation diagram showing a data structure of an item arrangement master data storage unit in accordance with one embodiment of the invention.

FIG. 12 An explanation diagram showing a data structure of a production ability master data storage unit in accordance with one embodiment of the invention.

FIG. 13 An explanation diagram showing a data structure of a priority order master data storage unit in accordance with one embodiment of the invention.

FIG. 14 An explanation diagram showing a data structure of a delivery date inquiry data storage unit in accordance with one embodiment of the invention.

FIG. 15 An explanation diagram showing a data structure of a sale quota data storage unit in accordance with one embodiment of the invention.

FIG. 16 An explanation diagram showing a data structure of a decision standard/criteria master data storage unit in accordance with one embodiment of the invention.

FIG. 17 A schematical sequence diagram of sale quota generation in accordance with one embodiment of the invention.

FIG. 18 A schematic sequence diagram of a process covering from delivery date inquiry to order acceptance processing in accordance with one embodiment of the invention.

FIG. 19 A schematic sequence diagram of sale quota alteration in accordance with one embodiment of the invention.

FIG. 20 A diagram for supplementary explanation of processing of S1702.

FIG. 21 A diagram for supplementary explanation of processing of S1702.

FIG. 22 A diagram for detailed explanation of processing of S1802.

FIG. 23A A diagram for detailed explanation of processing of S1803.

FIG. 23B A diagram for detailed explanation of the processing of S1803.

FIG. 24 A diagram for supplementary explanation of processing of S1803.

FIG. 25 A diagram for detailed explanation of processing of S1901.

FIG. 26 A diagram for detailed explanation of processing of S1902.

FIG. 27 A diagram for supplementary explanation of processing of S1801.

FIG. 28 A diagram for supplementary explanation of processing of S1904.

FIG. 29 A diagram for supplementary explanation of the processing of S1904.

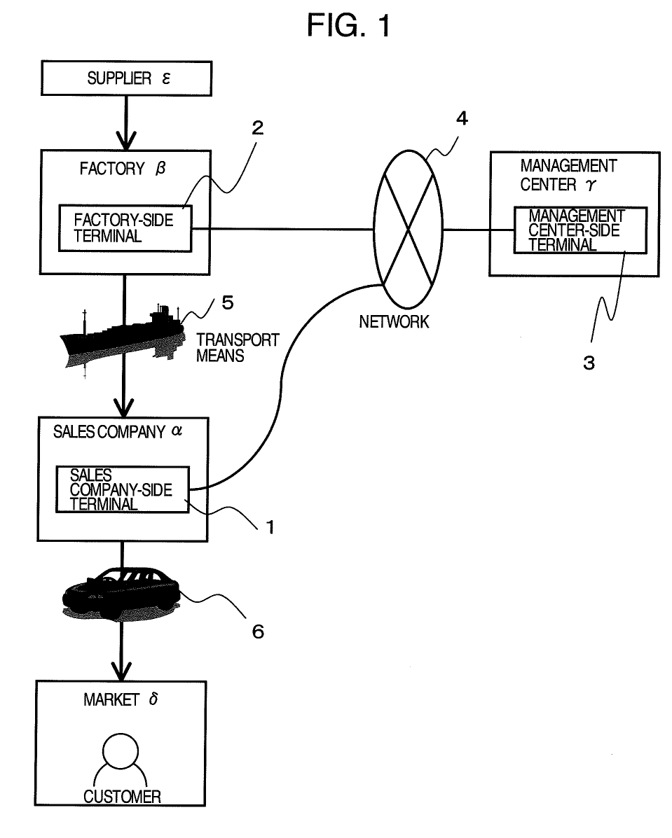

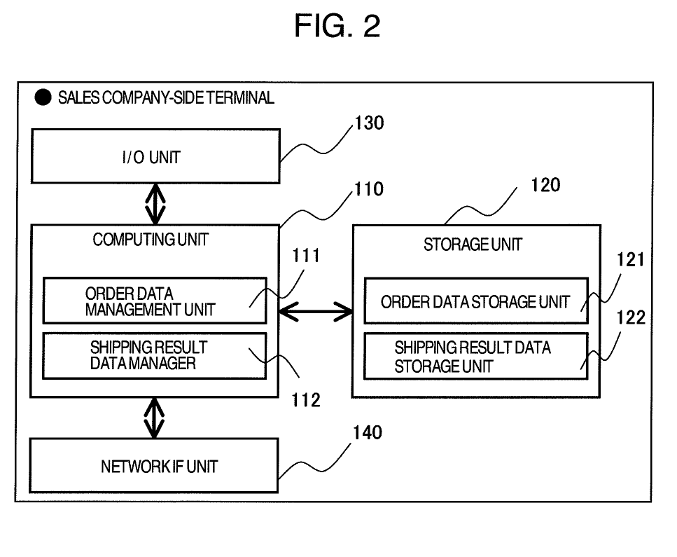

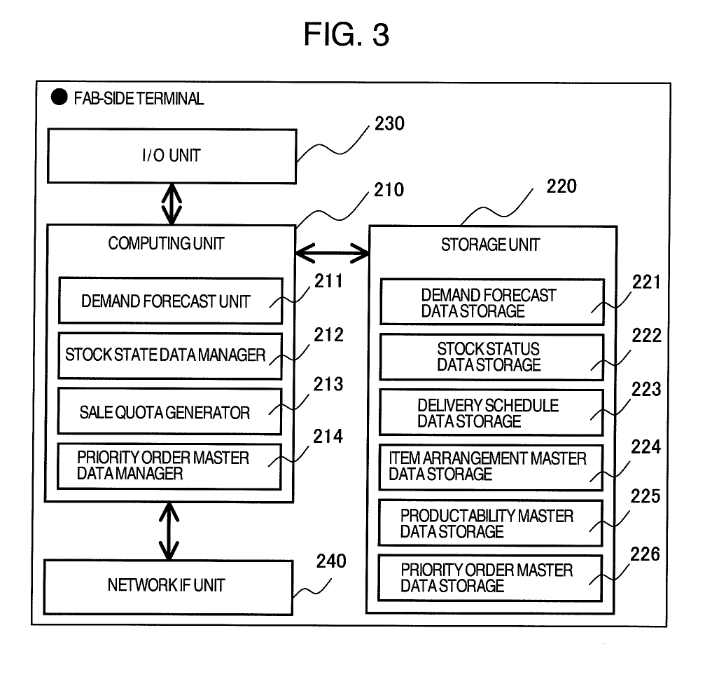

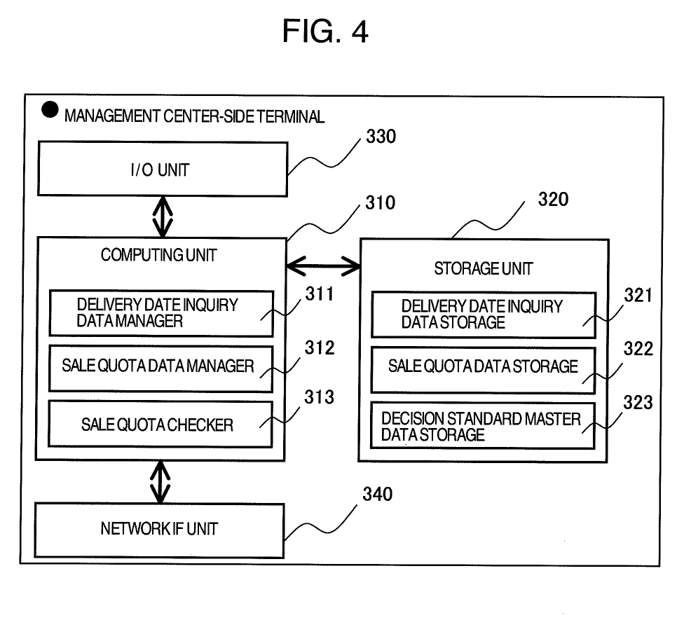

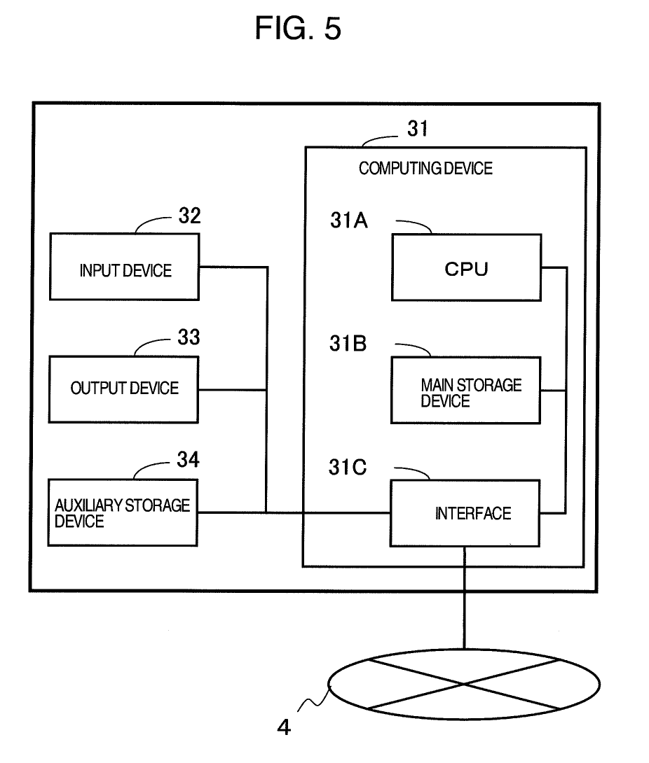

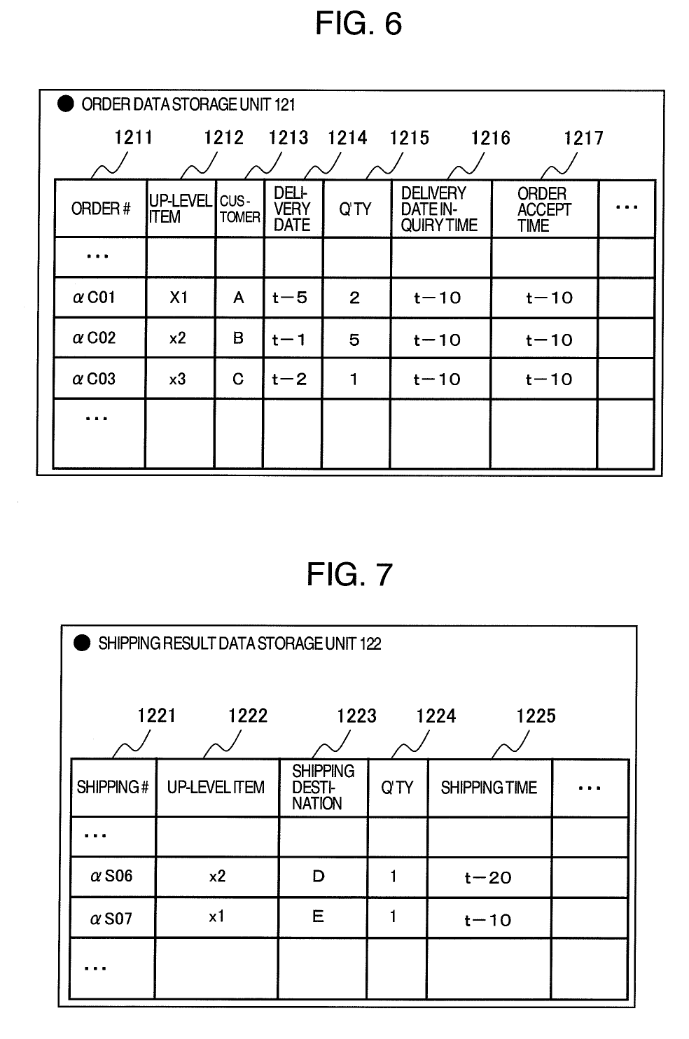

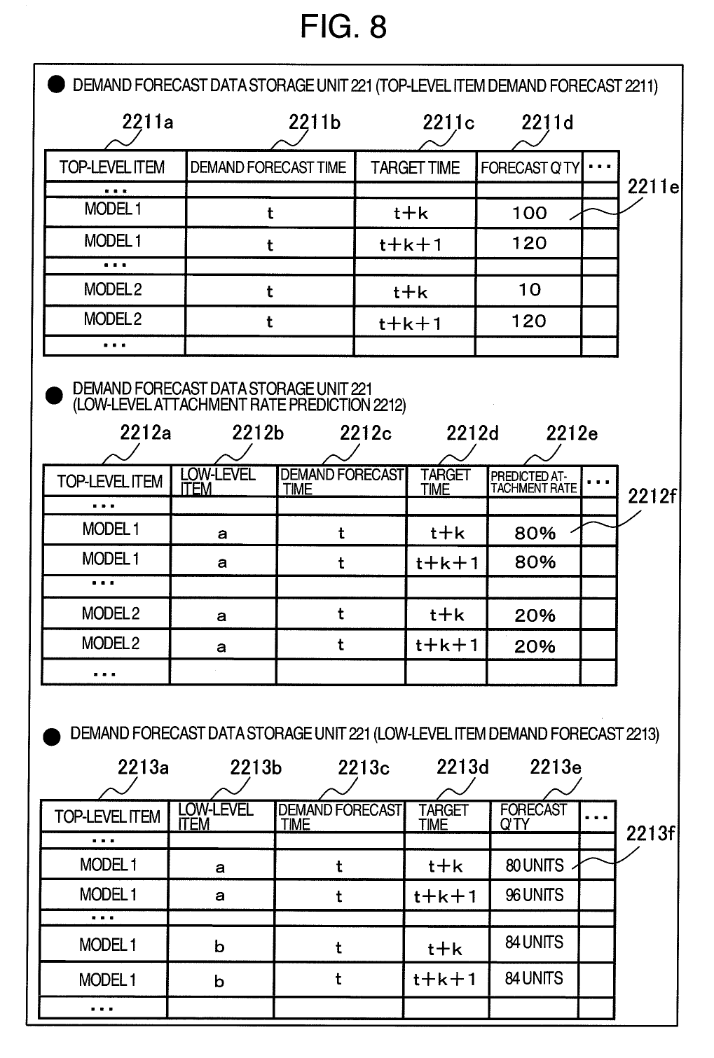

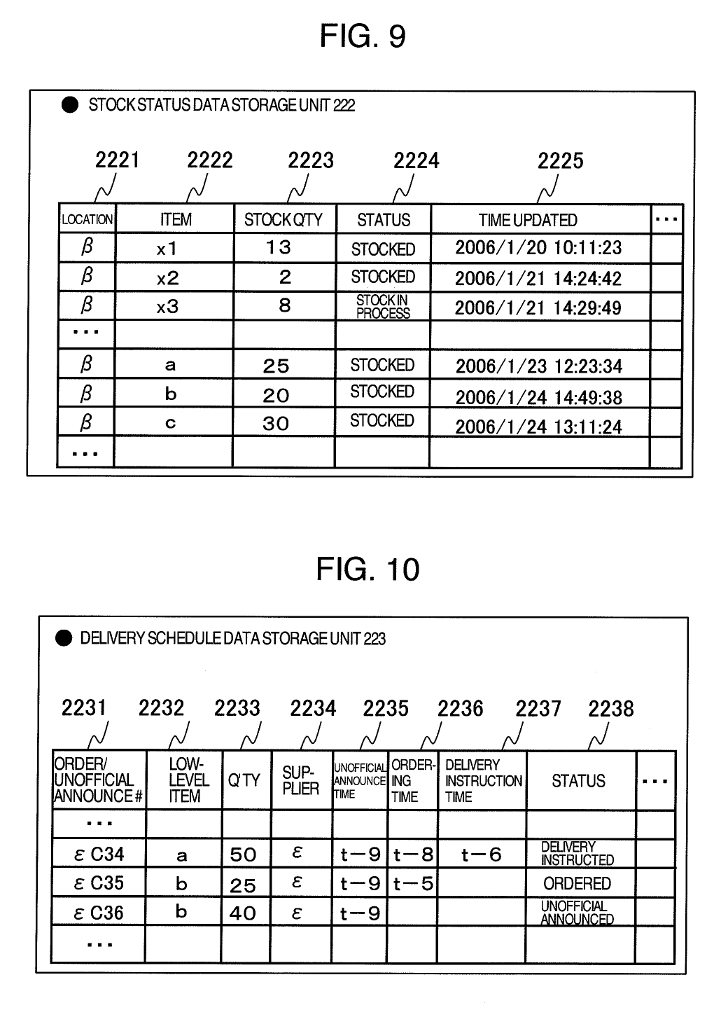

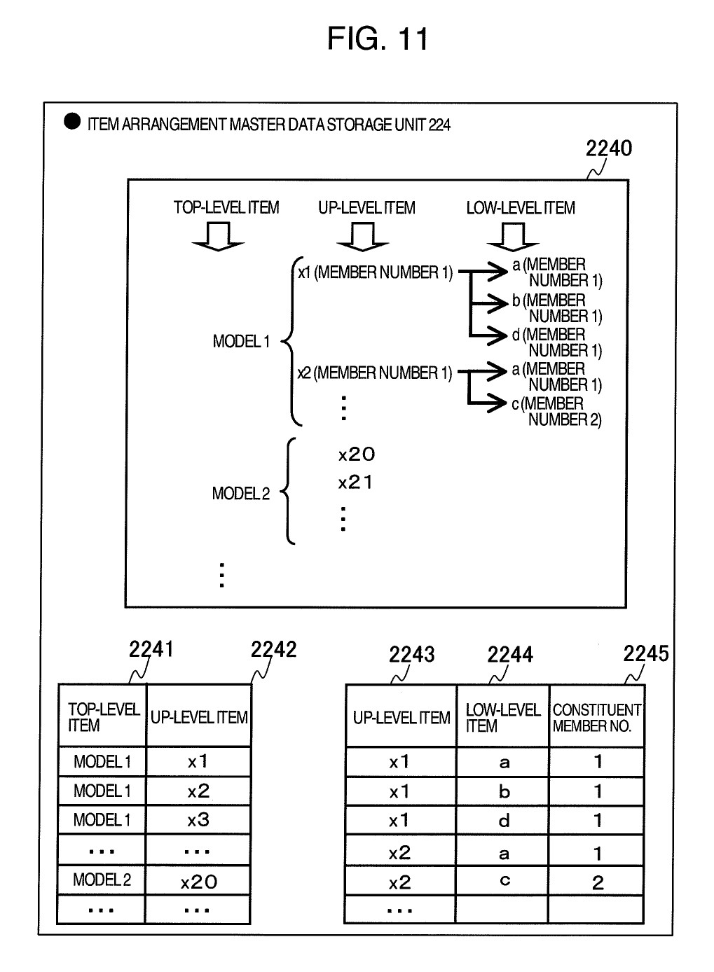

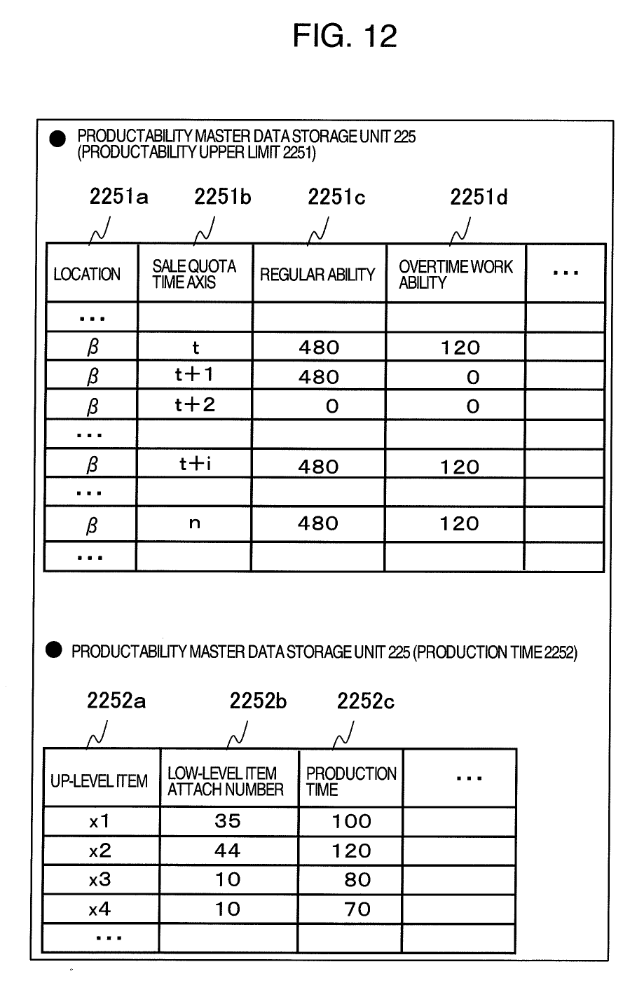

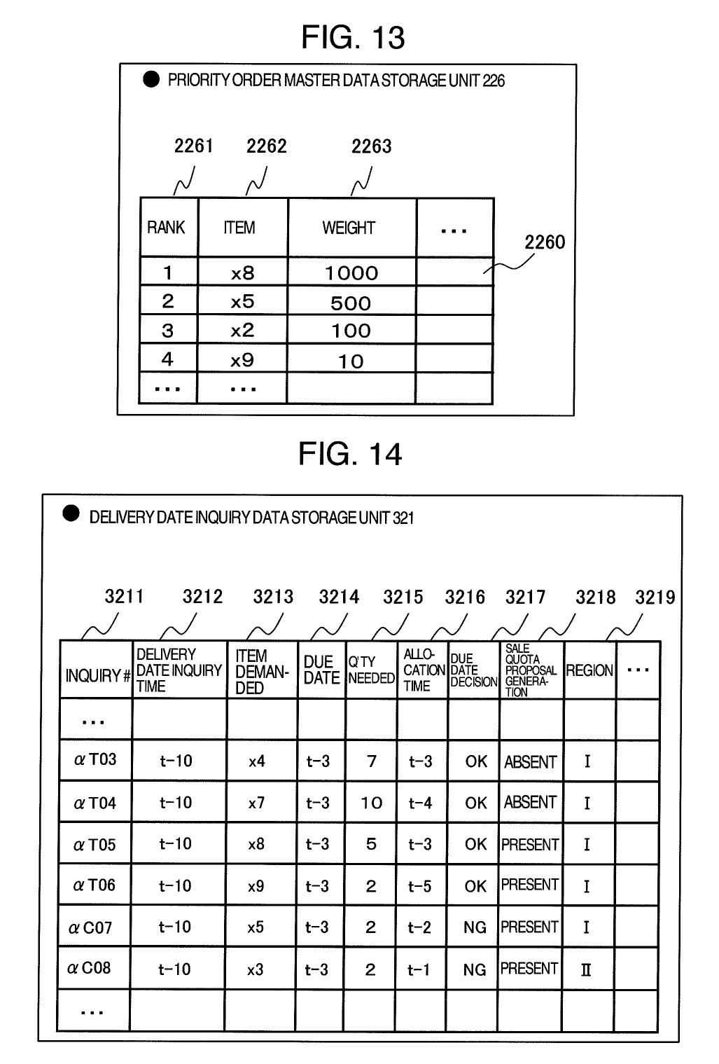

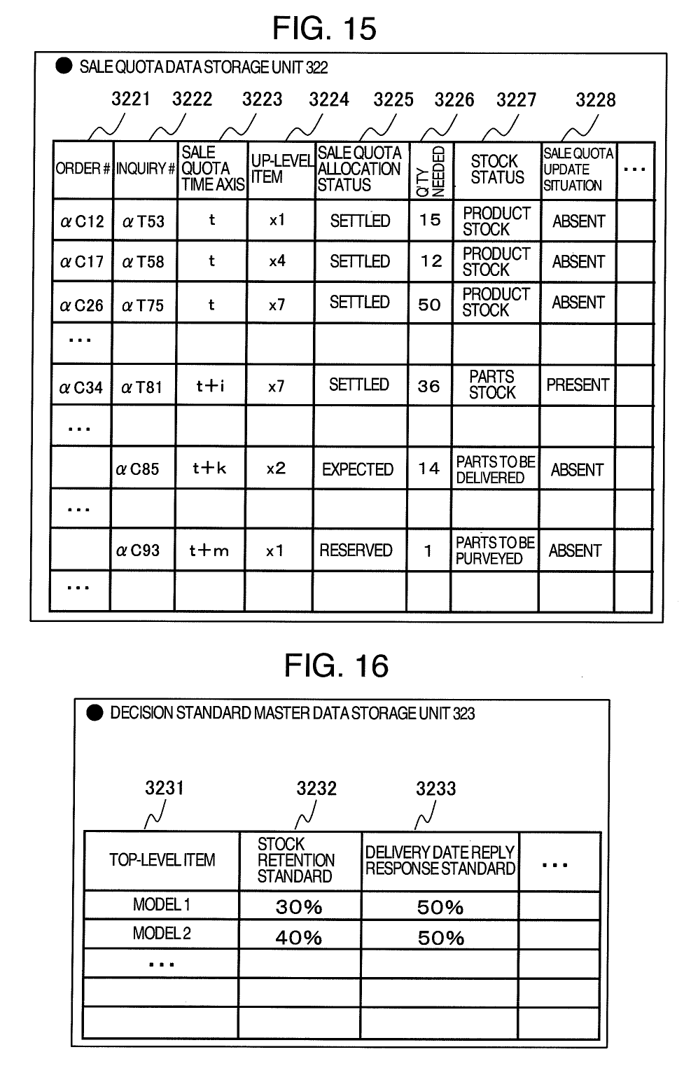

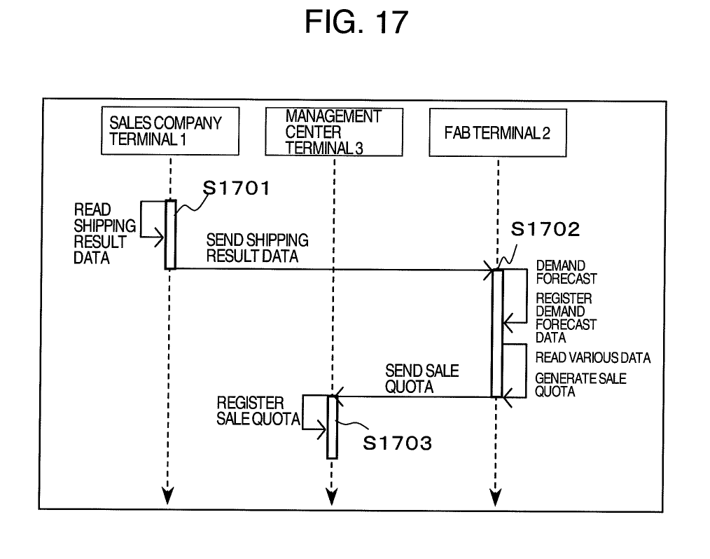

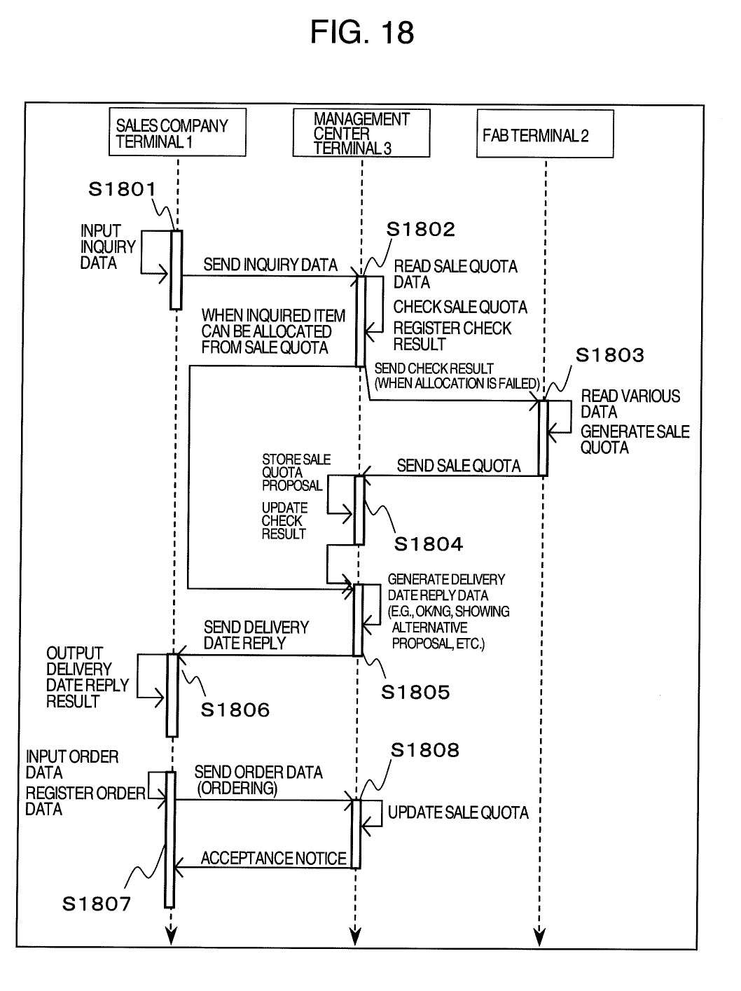

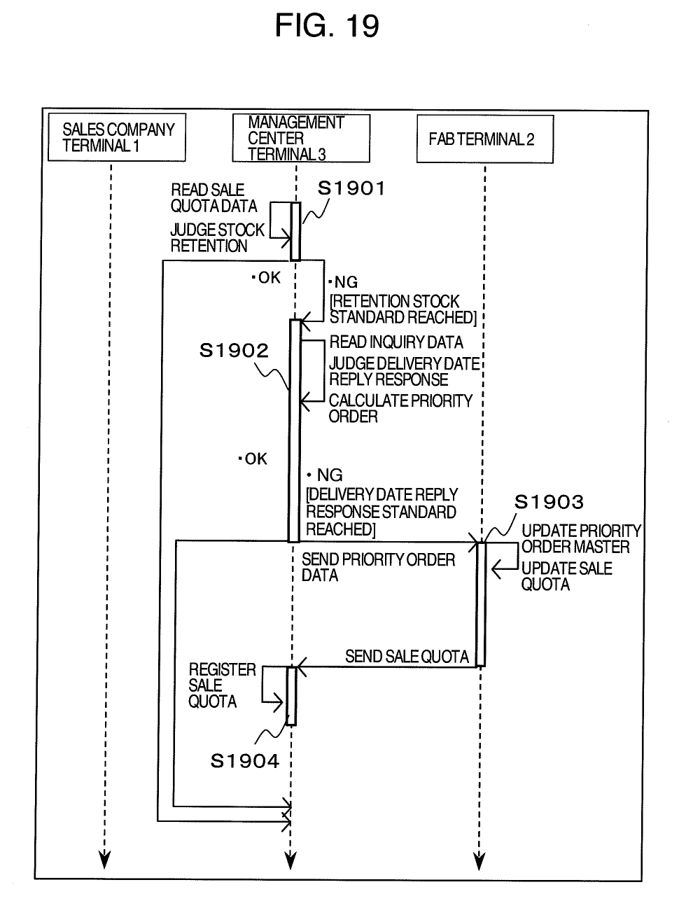

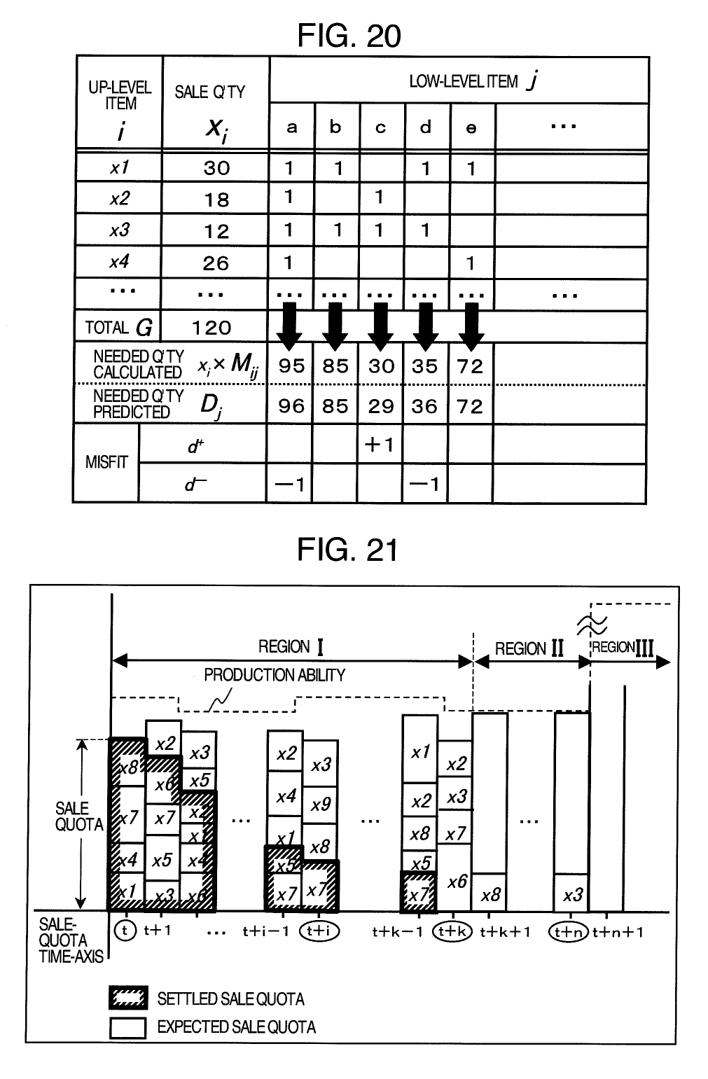

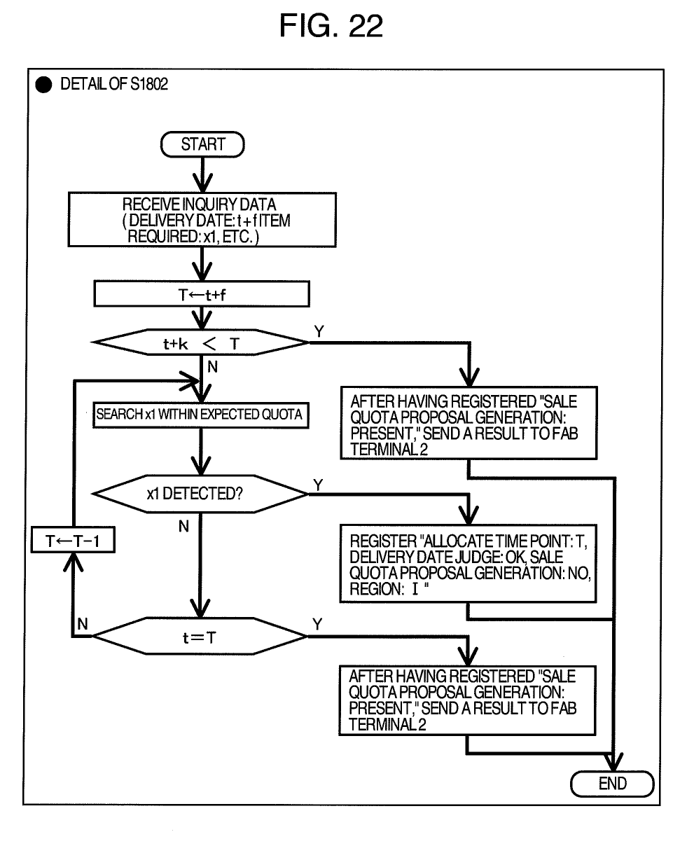

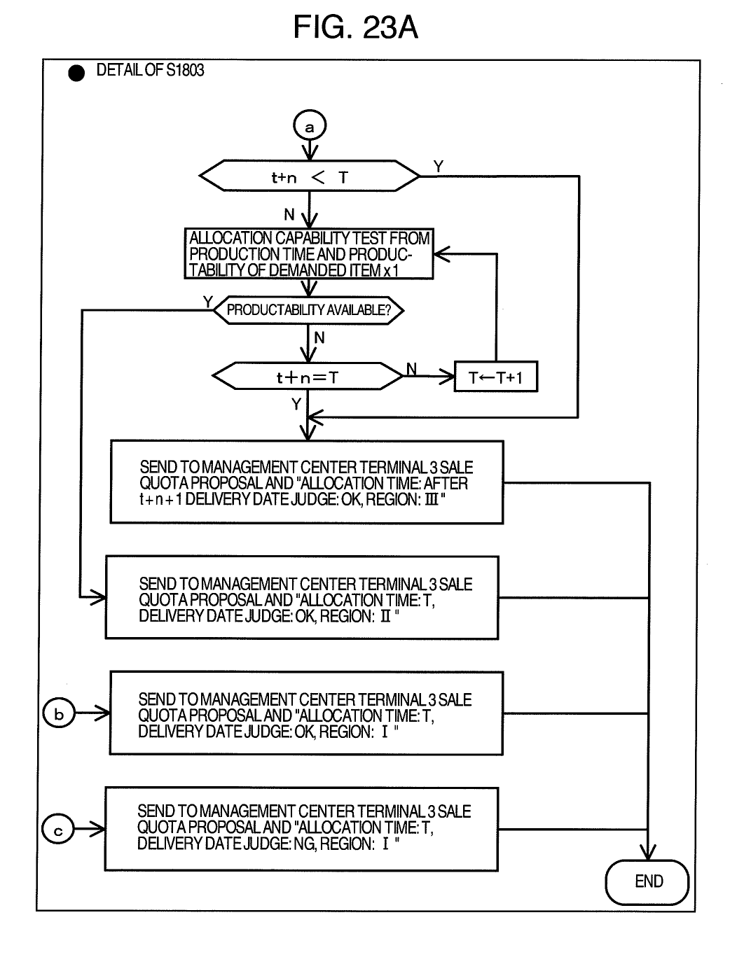

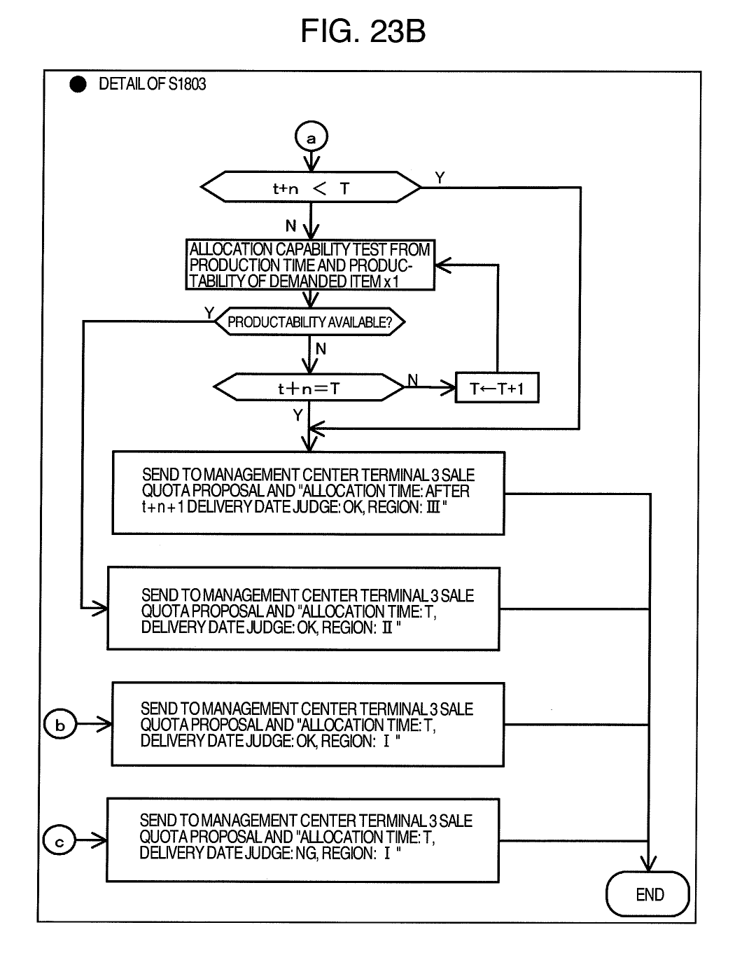

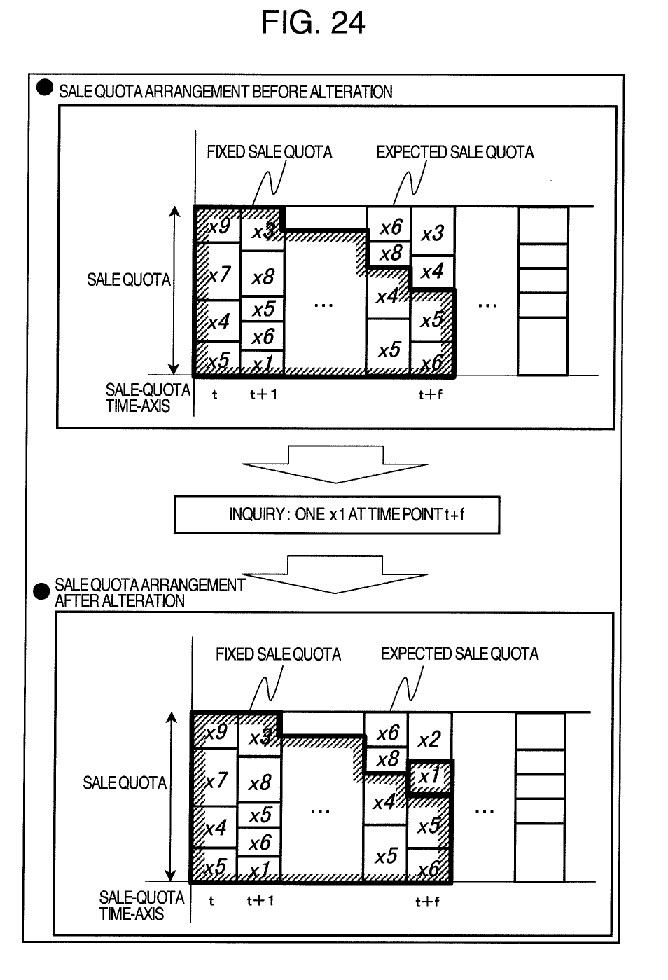

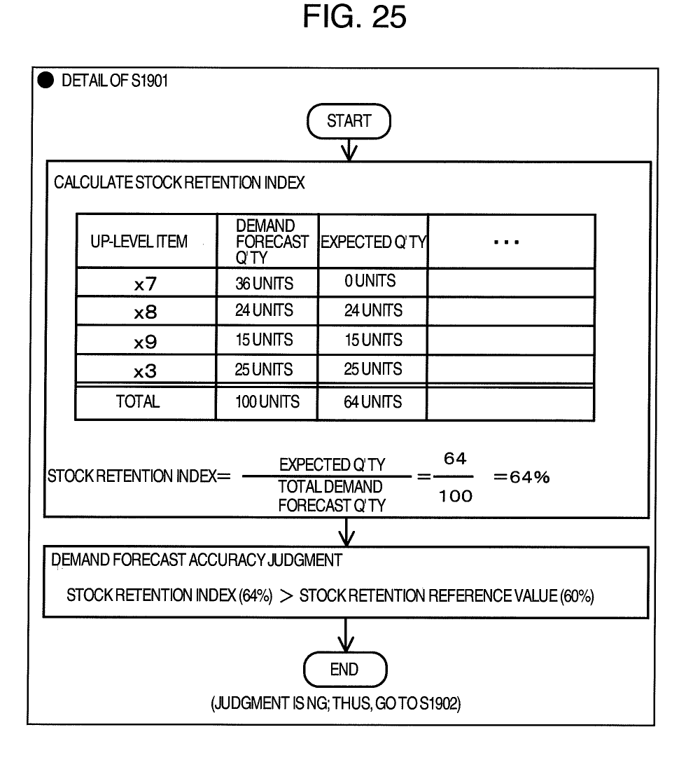

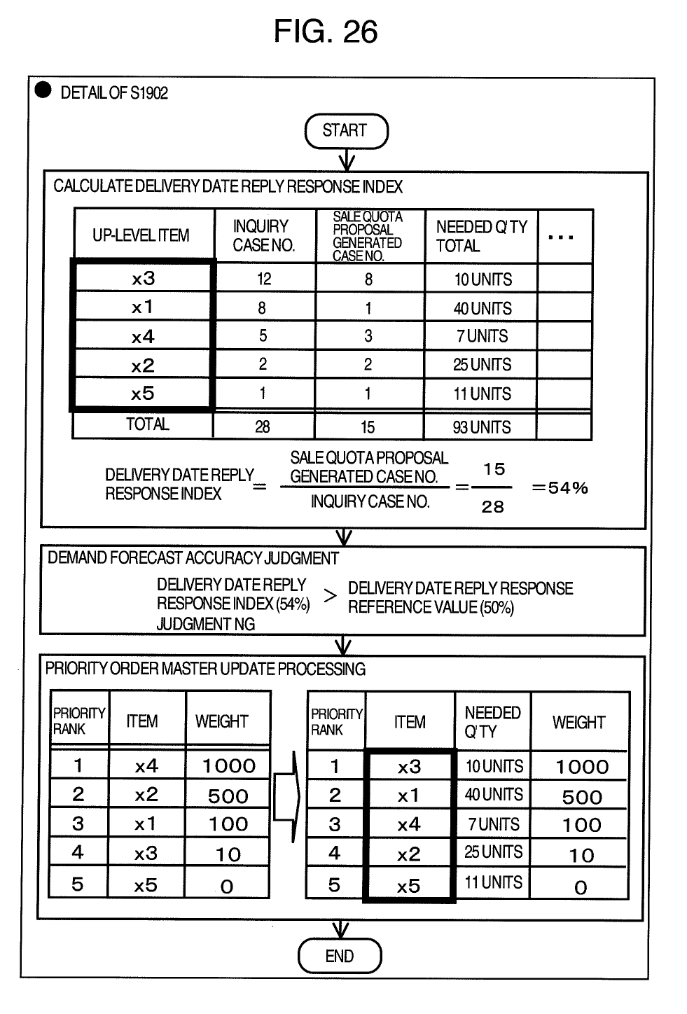

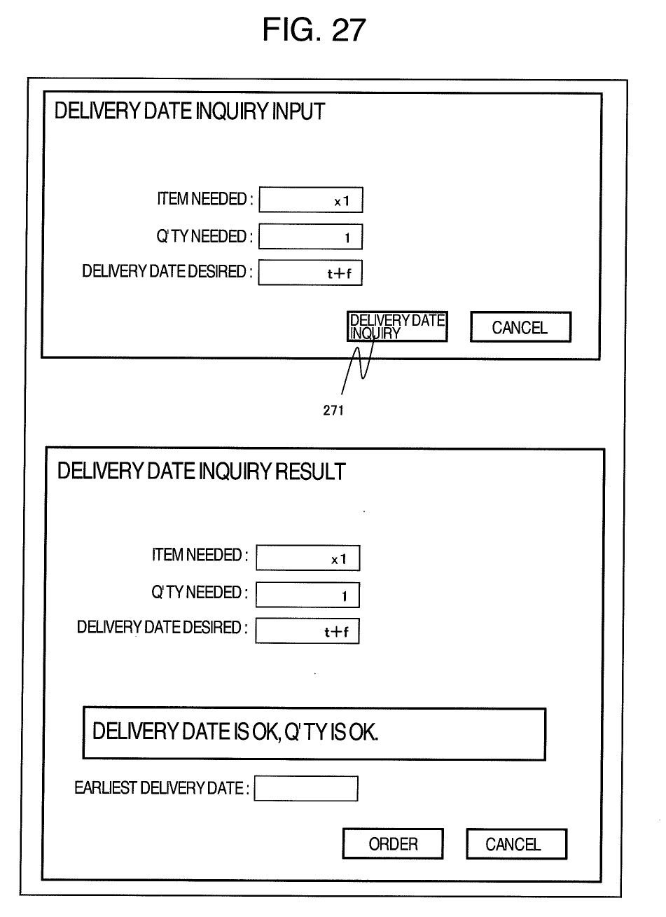

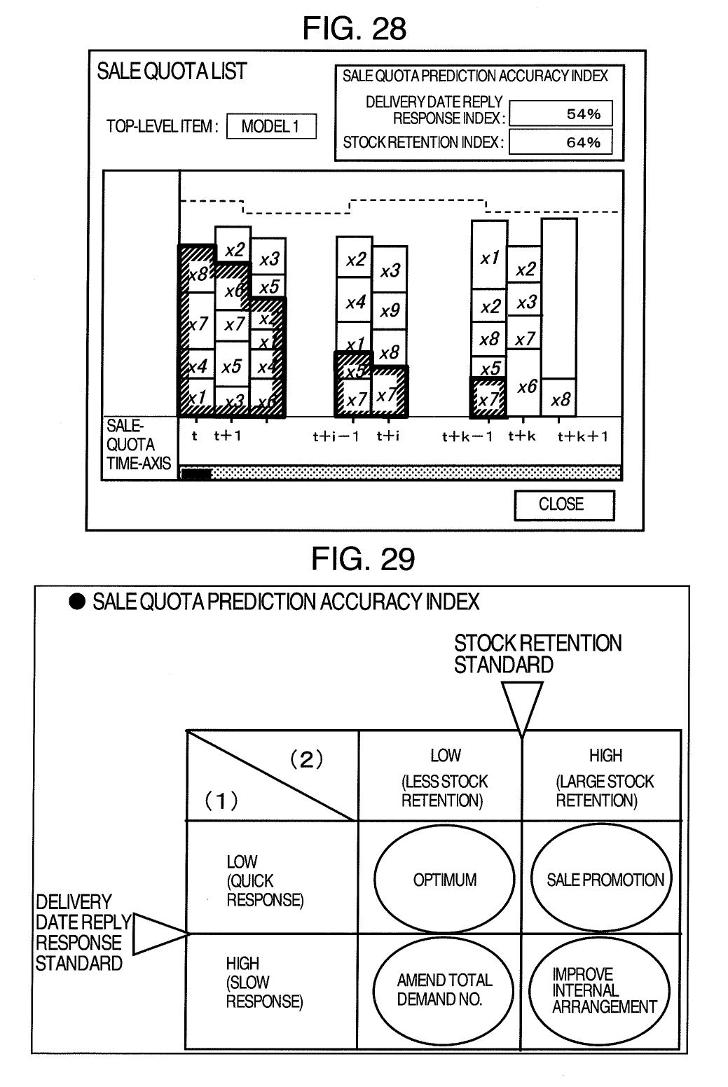

1. A delivery date reply system for managing more than one sellable distribution item as a sale quota containing therein at least identification information and quantity information thereof in a way corresponding to each sellable time point, having a sale quota data table for management of the sale quota while letting said sale quota be divided into a settled sale quota storing therein information of an item with its customer order being fixed and an expected sale quota storing therein information of an item expected to be sold which is determined by demand forecast based on actual shipping results, said system being responsive to receipt of a delivery date inquiry for replying a delivery date when the item under inquiry is allocatable for reservation from said expected sale quota, and for performing, when said item under inquiry is not allocatable from within said expected sale quota, sale quota alteration simulation to change the expected sale quota of said sale quota data table in such a way as to fully or partly satisfy the customer's desired delivery date and quantity and item contents to thereby send a reply as to the delivery date toward an inquiring party, characterized in that said delivery date reply system comprises:
means for storing a history record of reception of the delivery date inquiry and a history record of execution of the sale quota alteration simulation;
computation means for computing, based on the history data, a ratio of a number of cases with completion of the execution of said sale quota alteration simulation to a number of inquiries per unit time, for checking a resultant value in comparison with a predetermined reference value, and for detecting a change when the value is in excess of the predetermined reference value;
means for being rendered operative upon detection of said change by said computation means and for updating a priority order of a sale-expected item which becomes a base of generation of the sale quota; and
sale quota generator means for generating a new expected sale quota based on a result of said priority order updated.

2. A delivery date reply system as recited in claim 1, characterized by
performing demand forecast in units of low-order items making up said item under inquiry and prediction of a total sales number for each of said low-order items, and
calculating an optimal solution satisfying a goal of reducing excess and deficiency of components in stock based on the prediction result along with parts arrangement information, order information, stock information and priority order parameters to thereby calculate a sales number per item under said inquiry.

3. A delivery date reply system as recited in claim 1, characterized by calculating based on said history data a ratio of the cases with completion of the execution of said sale quota alteration simulation to a number of inquiries per unit time and displaying a result thereof at output means as predicted accuracy of the expected sale quota.

4. A delivery date reply method for managing more than one sellable distribution item as a sale quota containing therein at least identification information and quantity information thereof in a way corresponding to each sellable time point, having a sale quota data table for management of the sale quota while letting said sale quota be divided into a settled sale quota storing therein information of an item with its customer order being fixed and an expected sale quota storing therein information of an item expected to be sold which is determined by demand forecast based on actual shipping results, said method being responsive to receipt of a delivery date inquiry for replying a delivery date when the item under inquiry is allocatable for reservation from said expected sale quota, and for performing, when said item under inquiry is not allocatable from within said expected sale quota, sale quota alteration simulation to change the expected sale quota of said sale quota data table in such a way as to fully or partly satisfy the customer's desired delivery date and quantity plus item contents to thereby send a reply as to the delivery date toward an inquiring party, characterized in that said delivery date reply method comprises the steps of:
storing a history record of reception of the delivery date inquiry and a history record of execution of the sale quota alteration simulation;
computing, based on the history data, a ratio of a number of cases with completion of the execution of said sale quota alteration simulation to a number of inquiries per unit time, for checking a resultant value in comparison with a predetermined reference value and for detecting a change when the value is in excess of the predetermined reference value;
becoming operative upon detection of said change by said computation means to update a priority order of a sale-expected item which becomes a base of generation of the sale quota; and
generating a new expected sale quota based on a result of said priority order updated.

5. A delivery date reply method as recited in claim 4, characterized by including the steps of:
performing demand forecast in units of low-order items making up said item under inquiry and prediction of a total sales number for each of said low-order items, and
calculating an optimal solution satisfying a goal of reducing excess and deficiency of components in stock based on the prediction result along with parts arrangement information, order information, stock information and priority order parameters to thereby calculate a sales number per item under said inquiry.

6. A delivery date reply program for causing an information processing apparatus to execute a process having the steps of permitting preallotment of a sales quota of a sellable distribution item, responding to receipt of a delivery date inquiry for allocating for reservation a content of the inquiry from within the sale quota to thereby reply a delivery date and for making, when the inquiry content is failed to be allocated to the sale quota, a reply as to a delivery date after having performed sale quota alteration simulation for alteration to a sale quota with maximal satisfaction of a delivery date desired by a customer and quantity and item contents, characterized in that
said information processing apparatus comprises means for storing a history record of reception of the delivery date inquiry and a history record of execution of the sale quota alteration simulation, computation means for computing based on the history data a ratio of a number of cases with completion of the execution of said sale quota alteration simulation to a number of inquiries per unit time to thereby check a resultant value in comparison with a predetermined reference value and detect a change when the value is in excess of the predetermined reference value, means for being rendered operative upon detection of said change by said computation means and for updating a priority order of a sale-expected item which becomes a base of generation of the sale quota, and sale quota generator means for generating a new expected sale quota based on a result of said priority order updated, and that
said program achieves a process for updating, when said computation means detects said change, a priority order of a sale-expected item serving as a base of generation of an expected sale quota and a process for reading a result of the priority order to thereby newly generate a sale quota for use in allocation for reservation of the delivery date reply.

7. A delivery date reply program as recited in claim 6, characterized by achieving
a process of executing demand forecast in units of low-order items making up the item under inquiry and prediction of a total sales number per low-order item, and
a process of calculating an optimal solution satisfying a goal of reducing excess and deficiency of components in stock based on the prediction result along with parts arrangement information, order information, stock information and priority order parameters to thereby calculate a sales number per item under said inquiry.

8. A delivery date reply program as recited in claim 6, characterized by calculating based on said history data a ratio of the cases with completion of the execution of said sale quota alteration simulation to a number of inquiries per unit time and displaying a result thereof at output means as predicted accuracy of the expected sale quota.

9. A computer-readable recording medium storing therein the program as recited in claim 6.

10. A computer-readable recording medium storing therein the program as recited in claim 7.

11. A computer-readable recording medium storing therein the program as recited in claim 8.
